(19) United States
(12) Patent Application Publication
(10) Pub. No.: US 2025/0249472 A1
(43) Pub. Date: Aug. 7, 2025

(54) PUMP DISPENSER

(71) Applicant: The Procter & Gamble Company, Cincinnati, OH (US)

(72) Inventors: Wenhao ZHU, Beijing (CN); Yuanyuan CHEN, Beijing (CN); Dong RUAN, Beijing (CN)

(21) Appl. No.: 19/043,762

(22) Filed: Feb. 3, 2025

(30) Foreign Application Priority Data
Feb. 2, 2024 (WO) PCT/CN2024/075371

(51) Int. Cl. B05B 11/10; B05B 11/02

(52) U.S. Cl. CPC B05B 11/1001; B05B 11/028; B05B 11/1064; B05B 11/1074

(57) ABSTRACT

A pump dispenser and a pump head for dispensing a fluid product. The pump dispenser includes a container containing the fluid product to be dispensed, a slidable follower piston positioned at the bottom the container, and a pump assembly coupled at the upper portion of the container. The pump dispenser enables relatively high product dose dispensing with a consumer preferred compact container configuration. The pump dispenser can be an airless pump dispenser and can be used to dispense high viscosity fluid products.

### FIELD

The present disclosure is directed generally to a pump dispenser and a pump head. More specifically, the present disclosure is directed to a pump dispenser and a pump head that provides a compact pump dispenser capable of dispensing a relative high dose of a product with a high viscosity such as a dentifrice composition.

### BACKGROUND

Pump dispensers have been widely used in consumer goods especially for viscous materials, e.g., facial cream, hair shampoo, conditioner, body wash, body lotion or liquid hand wash. Among them, airless pump dispenser became popular as its airless pump mechanism provides advantages such as no left-over in container, better control on dosage, less contamination, hygiene maintenance in use, and longer shelf life, etc. Airless pump, as implied in its name, is configured to have a vacuum chamber in the dispenser system so that no air is released into the vessel after each dosage.

U.S. Pat. No. 4,875,604 disclosed a dispenser for paste-like products comprising a supply container and a cylinder body slidably supporting a dispensing piston connected to an actuator cap guided on the cylinder body. The dispensing piston cooperates with the cylinder body to define a pump chamber communicating with the interior of the supply container through another non-return valve. On the other side the bottom portion of the dispensing piston is provided with a non-return valve for establishing communication of the pump chamber with a tubular section carrying the dispensing piston and at the same time acting as an outlet passage for the paste-like product. The tubular section is integrally connected to the actuator cap, the latter being biased towards a rest position by a return spring supported on a fixed counter-stop, particularly on the cylinder body.

Such two-valve mechanism has been widely used in airless pump field for decades, and it is characterized by requiring a reduced number of components. However, a disadvantage of this mechanism is that the dosage of such pump is limited by the space of the pump chamber which is determined by the crowd configuration of the dispensing pump head mechanism. As disclosed in the reference described above herein, the dispensing piston has to be connected with the actuator cap and upper valve in most of current pump, in order to achieve the slidable movement along the interior of the cylinder body, thus the space of the pump chamber cannot be as large as desired.

Current solution for achieving a large dosage is to enlarge the whole size of the pump head, with which the better efficacy of product benefit can be delivered. However, consumer favor good looking, slim and elegant pump appearance at the same time. Thus, there is a need to provide high dose but with slim and compact package size to meet the consumer's requirement.

Therefore, there is a continuous need for an airless pump dispenser especially for high viscosity product which can provide a higher dosage but having desirably slim and compact package size, as well as not increasing manufacturing and assembly expenses.

### SUMMARY

In one aspect, the present invention is directed to a pump dispenser for dispensing a fluid product, comprising: an elongated container containing the fluid product to be dispensed, a slidable follower piston positioned at the bottom portion of the container, and a pump assembly coupled at the upper portion of the container, wherein the pump assembly comprising: an annular sleeve arrangement composed of a peripheral outer wall and a partition inner wall, a helical spring disposed in therebetween, a lower single-way valve provided in an opening formed in interior of said partition inner wall, a piston sealer fixedly connected to the partition inner wall, an actuator including an upper nozzle portion having an outlet, and a downwardly projecting base wall portion and an annular collar portion in between, wherein the base wall portion is slidably engaged with the piston sealer and supported by the helical spring in the annular space of the annular sleeve arrangement, an upper single-way valve provided on an opening formed in interior of the annular collar portion, through which the fluid product enters into the outlet of the upper nozzle portion, characterized in that the base wall portion, the annular collar portion, the piston sealer, the upper single-way valve and the lower single-way valve form a vacuumed chamber.

In another aspect, the present invention is directed to a pump head, comprising: an annular sleeve arrangement composed of a peripheral outer wall and a partition inner wall, a helical spring disposed in therebetween, a lower single-way valve provided in an opening formed in interior of said partition inner wall, a piston sealer fixedly connected to the partition inner wall, an actuator including an upper nozzle portion having an outlet, and a downwardly projecting base wall portion and an annular collar portion in between, wherein the base wall portion is slidably engaged with the piston sealer and supported by the helical spring in the annular space of the annular sleeve arrangement, an upper single-way valve provided on an opening formed in interior of the annular collar portion, through which the fluid product enters into the outlet of the upper nozzle portion, characterized in that the base wall portion, the annular collar portion, the piston sealer, the upper single-way valve and the lower single-way valve form a vacuumed chamber.

In another aspect, the invention provides for a method of using the pump dispenser described herein, comprising holding the container and press the actuator by finger or thumb to dispense the fluid product.

Without being bound by any theory, the configuration of the pump dispenser described in the present invention provide larger chamber space in the pump head compared to conventional pump designs, by making piston sealer fixedly connected to the partition inner wall, but not connected to the actuator mechanically. Such configuration surprisingly broadens the chamber space maximumly and make it possible to provide desirable large amount of fluid out of a relatively small volume container, which enabled a relatively slim and elegant container.

An advantage for the present invention is to provide a dispenser for liquid or paste-like product, especially high viscosity product, comprising two-valve pump chamber means.

Another advantage for the present invention is to provide a dispenser having a high dosage while keeping a relatively slim and compact container size.

Another advantage for the present invention is to provide a dispenser consisting of considerably reduced number of separate components, and a resultant reduction of manufacturing and assembly expenses as compared to conventional dispensers.

Another advantage for the present invention is to provide a dispenser considerably improve the economic aspects in the manufacture of the dispenser while maintaining its usefulness.

Still another advantage for the present invention is provide a dispenser which is also characterized by high reliability and simple operability.

### BRIEF DESCRIPTION OF THE DRAWINGS

While the specification concludes with claims particularly pointing out and distinctly claiming the invention, it is believed that the invention will be better understood from the following description of the accompanying figures in which like reference numerals identify like elements, and wherein:

FIG. 1 shows an example of an inventive pump dispenser.

FIG. 2 shows an enlarged illustration of longitudinal sectional view of an exemplary pump head of the pump dispenser of FIG. 1.

FIGS. 3 and 4 shows an embodiment of an element of the pump head of the pump dispenser.

FIG. 5 shows a longitudinal sectional view of an exemplary pump head.

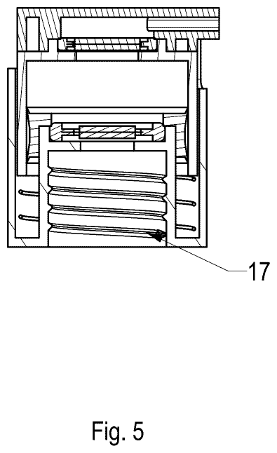

FIG. 6 shows a longitudinal sectional view of an inventive pump dispenser.

### DETAILED DESCRIPTION

Reference within the specification to “embodiment(s)” or the like means that a particular material, feature, structure and/or characteristic described in connection with the embodiment is included in at least one embodiment, optionally a number of embodiments, but it does not mean that all embodiments incorporate the material, feature, structure, and/or characteristic described. Furthermore, materials, features, structures and/or characteristics may be combined in any suitable manner across different embodiments, and materials, features, structures and/or characteristics may be omitted or substituted from what is described. Thus, embodiments and aspects described herein may comprise or be combinable with elements or components of other embodiments and/or aspects despite not being expressly exemplified in combination, unless otherwise stated or an incompatibility is stated.

All ranges are inclusive and combinable. For example, all numeric ranges are inclusive of narrower ranges, and delineated upper and lower range limits are interchangeable to create further ranges not explicitly delineated. The terms “comprising”, “having”, “containing”, and “including” means that other steps, ingredients, elements, etc. which do not adversely affect the end result can be added. Each of these terms encompasses the terms “consisting of” and “consisting essentially of”. The singular forms “a,” “an,” and “the” are intended to include the plural forms as well, unless the context clearly indicates otherwise.

“Consumers” means customers who purchase a product, users of the product, and store owners or managers who stock their shelves with the product.

“Oral care product” means a product, which in the ordinary course of usage, is not intentionally swallowed for purposes of systemic administration of particular therapeutic agents, but is rather retained in the oral cavity for a time sufficient to contact substantially all of the dental surfaces (i.e., tooth) and/or oral tissues for treatment of oral cavity sensitivity. The oral care product may be in various forms including toothpaste, dentifrice, tooth gel, subgingival gel, mouth rinse, mousse, foam or denture product. The term “oral care product” may also include treatment regimens where these aforementioned compositions may be applied to teeth via an implement, such as a toothbrush or the like.

“Dentifrice product” means a tooth or subgingival-paste, gel, or liquid formulations unless otherwise specified. The dentifrice composition may be in any desired form, such as deep striped, surface striped, multilayered, having a gel surrounding a paste, or any combination thereof. Each dentifrice composition in a dentifrice comprising two or more separate dentifrice compositions may be contained in a physically separated compartment of a dispenser and dispensed side-by-side.

References number:

| | |
|---|---|
| 1 | the pump dispenser |
| 2 | elongated container |
| 3 | follower piston |
| 4 | pump assembly |
| 5 | actuator |
| 6 | upper single-way valve |
| 7 | annular collar portion |
| 8 | lower single-way valve |
| 9 | piston sealer |
| 10 | vacuumed chamber |
| 11 | helical spring |
| 12 | annular sleeve arrangement |
| 13 | peripheral outer wall |
| 14 | partition inner wall |
| 15 | annular space |
| 16 | protrusion |
| 17 | inner sleeve |
| 18 | recess |
| 19 | constraint outer shell |
| 20 | base wall portion |
| 21 | outlet |
| 22 | upper nozzle portion |

### Pump Dispenser

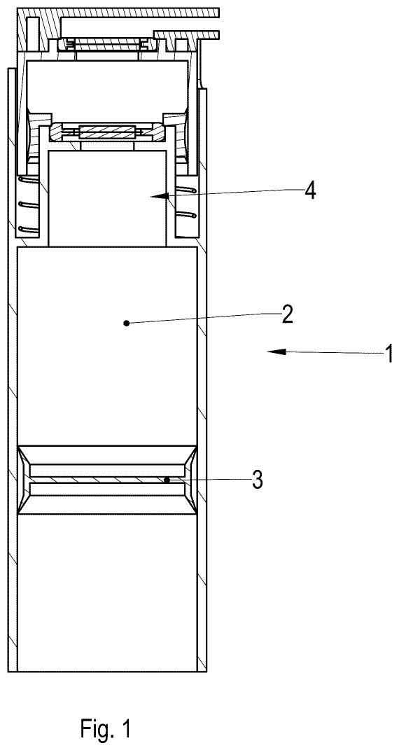

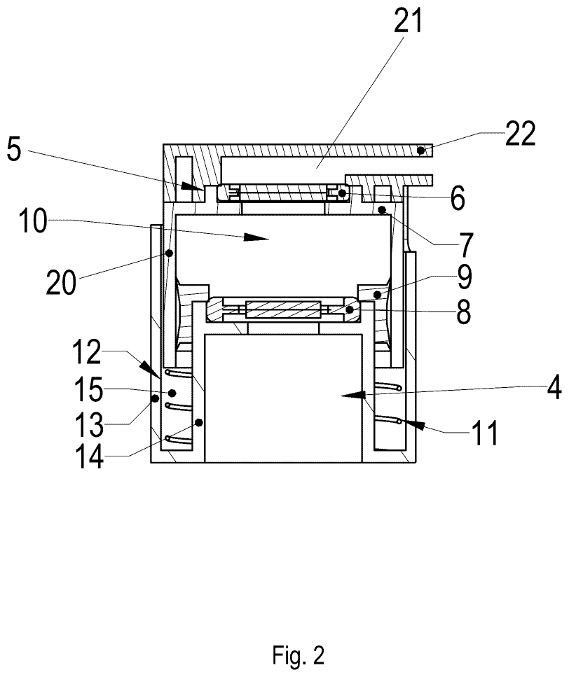

FIG. 1 and FIG. 2 show an example of the novel pump dispenser (1) herein. FIG. 1 shows a front view of the pump dispenser (1). FIG. 2 shows an enlarged illustration of the pump assembly (4) of FIG. 1.

FIG. 1 shows a pump dispenser (1) for dispensing a fluid product. The pump dispenser (1) comprises an elongated container (2) and a pump assembly (4), which may also be referred to as a pump head. The elongated container (2) may contain a fluid product to be dispensed. The container (2) can be any suitable shape, e.g., cylindrical. The elongated container (2) extends along a longitudinal axis (L) and has a closed bottom portion and an open upper portion which is coupled to the pump assembly (4). The individual components of the pump dispenser (1) may be made of any suitable material such as an injection-moldable plastic (e.g., polyethylene or polypropylene), to provide a pump dispenser that is of a lightweight construction, and which does not affect the fluid product that may be contained therein.

A follower piston (3) is slidably mounted for displacement within the container (2) at the closed bottom portion. The slidable follower piston (3) may contact the fluid product and can slidably move from the closed bottom portion towards upper portion in the container (2) by the action thereon of the surrounding atmospheric pressure, so that container is emptied from bottom to top during use of dispenser.

FIG. 2, shows an enlarged illustration of the pump assembly (4) of FIG. 1, together with a more detailed illustration of some of the components the pump assembly (4).

As shown in FIG. 2, the pump assembly (4) comprises an annular sleeve arrangement (12). The annular sleeve arrangement (12) includes a peripheral outer wall (13) and a partition inner wall (14) that define an annular space (15) between them. The peripheral outer wall (13) of the pump assembly (4) may be integrally formed with the outer wall of the container (2) or a separate part. The diameter of the peripheral outer wall (13), e.g., in a cylindrical shape, may be the same as the diameter of the container (2), such that pump dispenser (1) as a whole has a smooth cylindrical outer shape. The partition inner wall (14) is an annular sleeve wall having a smaller diameter than the peripheral outer wall (13) and is connected with the peripheral outer wall (13) at the bottom to form a closed end, which is an annular space (15). The annular sleeve arrangement (12) can be a guide and retention means for the actuator (5).

A helical spring (11) is disposed in the annular space (15) formed between the peripheral outer wall (13) and the partition inner wall (14). The outer diameter of helical spring (11) is selected so that the interior surface of annular space (15) acts as a guide for helical spring (11). The helical spring (11) may be held under compression between the closed end in the annular space (15) of the annular sleeve arrangement (12) and the downwardly projecting base wall portion (20) of the actuator (5).

The top end shoulder of the partition inner wall (14) is defined by an end wall formed with a central opening interiorly. A lower single-way valve (8) is provided on top of the central opening formed in interior of said partition inner wall (14).

A piston sealer (9) is provided to fixedly connect to the partition inner wall (14), preferably is fixedly positioned on the top end shoulder of the partition inner wall (14). This piston sealer (9) is not movable together with the partition inner wall (14). Differentiated from known art solution in which piston and actuator mechanism including piston occupied too much room for moving, this unique configuration separates the piston sealer part from actuator part, makes it possible to provide larger vacuumed chamber space so that a larger dosage can be dispensed even in a compressed slim container.

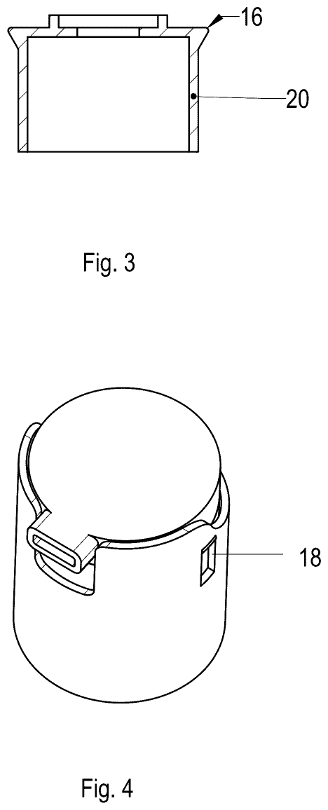

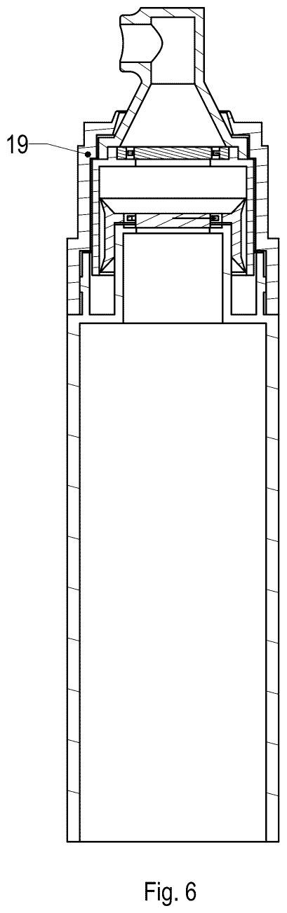

As illustrated in FIG. 2, the actuator (5) includes an upper nozzle portion (22) having an outlet (21) that provides a passage through which the fluid product is dispensed. The actuator (5) further comprises a downwardly projecting base wall portion (20) and an annular collar portion (7) between of the upper nozzle portion (22) and base wall portion (20). The downwardly projecting base wall portion (20) is slidably engaged with the piston sealer (9) and supported by the helical spring (11) in the annular space (15) of the annular sleeve arrangement (12). In the absence of an actuating force, the actuator (5) is maintained in the position shown in FIG. 2. When the actuator (5) is pressed, the based wall portion (20) moves downwardly by sliding against the piston scaler (9). When the actuator (5) is released, the base wall portion (20) moves upwardly back to its original position by the counterforce of the helical spring (11). In order to ensure the base wall portion (20) returns to the original position and does not move beyond the original position, a locking mechanism may be provided on the base wall portion (20). The lock mechanism may be a protrusion (16), for example, as shown in FIG. 3. The protrusion (16) may snap into a recess (18) on the peripheral outer wall (13) of the annular sleeve arrangement (12), for example, as shown in FIG. 4. In another example, the lock mechanism may be a constraint outer shell (19), as shown in FIG. 6, wherein said outer shell (19) is positioned circumferentially out of the downwardly projecting base wall portion of the actuator.

In some embodiments, the annular collar portion (7) is integral to the base wall portion (20) and having a central opening. An upper single-way valve (6) is provided on the central opening formed in the interior of the annular collar portion (7). Through this upper single-way valve (6), the fluid product enters into the outlet (21) of the upper nozzle portion (22) and being dispensed out. The upper single-way valve could be a resilience sheet structure or a rigid ball, as long as it can provide the single-way passage upon pressure.

The base wall portion (20), the annular collar portion (7) of the actuator (5), the piston sealer (9), the upper single-way valve (6) and the lower single-way valve (8) may form a vacuumed chamber (10). The volume of vacuumed chamber (10) is maximum at the rest potion of the actuator, and is reduced when the actuator is pressed. The vacuumed chamber (10) may have a cross-sectional area of 50% to 95% (e.g., 60% to 90% or 65% to 85%) of the cross-sectional area of the pump assembly (4).

Depression of actuator (5) causes the fluid product to be expelled from the vacuumed chamber (10) through outlet passage (21), while the return of actuator (5) to its rest position causes a charge of the fluid product to be sucked into vacuum chamber (10) from container (2). Specifically, when in use, the user presses the actuator (5) downwardly, volume of the chamber is compressed and the air pressure in the chamber rises, and the upper single-way valve (6) is opened, so that the fluid in the vacuumed chamber is extruded out of the outlet (21). The user releases the pressing on actuator (5), and the base wall portion and nozzle portion move backwards under the action of the elastic restoring force of the spring and return to the starting position. At this time, the upper valve (6) is closed. As the inner space of the chamber increases, the air pressure drop forms a vacuum, and the lower single-way valve (8) is opened, so that the fluid in the container (2) enters the chamber, and the follower piston (3) moves up towards the outlet by the atmosphere. When the user presses the actuator (5) again, the fluid in the pump chamber is extruded again out of the outlet (21).

The pump dispenser (1) includes a pump head for dispensing a fluid product, comprising:
a) an annular sleeve arrangement (12), said annular sleeve arrangement (12) is composed of a peripheral outer wall (13) and a partition inner wall (14) and in between forming an annular space (15),
b) a helical spring (11) disposed in the annular space (15) of the annular sleeve arrangement (12),
c) a lower single-way valve (8) provided in an opening formed in interior of said partition inner wall (14),
d) a piston sealer (9) fixedly connected to the partition inner wall (14),
e) an actuator (5) including an upper nozzle portion (22) having an outlet (21), and a downwardly projecting base wall portion (20) and an annular collar portion (7) in between, wherein the outlet is a passage where the fluid product is dispensed out, wherein the base wall portion is slidably engaged with the piston sealer (9) and supported by the helical spring (11) in the annular space (15) of the annular sleeve arrangement (12),
f) an upper single-way valve (6) provided on an opening formed in interior of the annular collar portion (7), through which the fluid product enters the outlet (21) of the upper nozzle portion (22),
   wherein the base wall portion (20), the annular collar portion (7) of the actuator (5), the piston sealer (9), the upper single-way valve (6) and the lower single-way valve (8) form a vacuumed chamber (10).

The chamber space may have a cross-sectional area of 50% to 95%, (e.g., 60% to 90% or 65% to 85%) of the cross-sectional area of the container.

In a particularly suitable example, the pump head may include an inner sleeve (17) defined by an inner surface of the partition inner wall (14), wherein the inner sleeve can be attached to a squeezable tube or a flexible bagpack containing a fluid product to be dispensed. The inner sleeve (17) could have a screwed mechanism or a snap mechanism to be attached to a squeezable tube or a flexible bagpack. In another example, the inner sleeve (17) can be attached to a cartridge like elongated container containing a slidable follower piston positioned at the bottom portion of the container.

FIG. 6 shows an example of the nozzle portion (20) with a different shape. Of course, it is to be appreciated that the nozzle portion (20) may be any suitable shape, as desired.

It should be noted that the Figures described above provide a non-limiting example of the pumping dispensing container and the pumping member thereof, which is merely for illustrating an implementation of the pumping action of the pumping dispensing container. However, the pumping dispensing container and the pumping member thereof of the present disclosure are in no way limited to the illustrated pumping dispensing container and the pumping member thereof. In fact, any pumped dispenser system can be applied to the pumped dispensing container according to the present disclosure described in detail below as long as it is capable of pumping a fluid, in particular a viscous fluid such as a paste.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A pump dispenser for dispensing a fluid product, comprising an elongated container containing the fluid product to be dispensed, a slidable follower piston positioned at the bottom portion of the container, and a pump assembly coupled at the upper portion of the container, wherein the pump assembly comprising:
a) an annular sleeve arrangement comprising a peripheral outer wall and a partition inner wall that define an annular space therebetween;
b) a helical spring disposed in the annular space of the annular sleeve arrangement;
c) a lower single-way valve provided in an opening formed interior of said partition inner wall:
d) a piston sealer fixedly connected to the partition inner wall;
e) an actuator comprising an outlet through which the fluid product is dispensed, a downwardly projecting base wall portion, and an annular collar portion, wherein the base wall portion is slidably engaged with the piston sealer and supported by the helical spring; and
f) an upper single-way valve disposed in the annular collar portion, through which the fluid product enters the outlet,
wherein the base wall portion, the annular collar portion of the actuator, the piston sealer, the upper single-way valve and the lower single-way valve form a vacuumed chamber.

2. The pump dispenser according to claim 1, wherein the downwardly projecting base wall portion of the actuator comprises a locking mechanism to limit axial upward movement of the actuator.

3. The pump dispenser according to claim 2, wherein the locking mechanism is at least one protrusion on the downwardly projecting base wall portion of the actuator, and wherein said at least one protrusion is stopped by a recess on the peripheral outer wall of the annular sleeve arrangement.

4. The pump dispenser according to claim 2, wherein the locking mechanism is a constraint outer shell positioned circumferentially out of the downwardly projecting base wall portion of the actuator.

5. The pump dispenser according to claim 1, wherein the vacuumed chamber has a cross-sectional area of 50% to 95% of the cross-sectional area of the pump assembly.

6. The pump dispenser according to claim 1, wherein the upper single-way valve and the lower single-way valve are each selected from a resilience sheet structure or a rigid ball.

7. A method of using the dispenser system of claim 1, comprising holding the container and actuating the actuator of the pump assembly to dispense the fluid product.

8. A pump head for a dispenser for dispensing a fluid product, comprising:
an annular sleeve arrangement comprising a peripheral outer wall and a partition inner wall that define an annular space therebetween;
a helical spring disposed in the annular space of the annular sleeve arrangement,
a lower single-way valve disposed in said partition inner wall,
a piston sealer fixedly connected to the partition inner wall,
an actuator comprising an outlet through which the fluid product is dispensed, a downwardly projecting base wall portion and an annular collar portion therebetween, wherein the base wall portion is slidably engaged with the piston sealer and supported by the helical spring in the annular space of the annular sleeve arrangement,
an upper single-way valve disposed in the annular collar portion, through which the fluid product enters the outlet,
wherein the base wall portion, the annular collar portion of the actuator, the piston sealer, the upper single-way valve and the lower single-way valve form a vacuumed chamber.

9. The pump head according to claim 8, wherein the chamber space has a cross-sectional area of 50% to 95% of the cross-sectional area of the pump head.

10. The pump head according to claim 8, wherein the pump head further comprises an inner sleeve defined by inner surface of the partition inner wall, wherein the inner sleeve is attached to a container containing a slidable follower piston positioned at the bottom portion of the container.

11. The pump head according to claim 8, wherein the pump head further comprises an inner sleeve defined by inner surface of the partition inner wall, wherein the inner sleeve attached to a squeezable tube or a flexible bag-pack containing the fluid product to be dispensed.
